(19) United States
(12) Patent Application Publication
(10) Pub. No.: US 2014/0174840 A1
(43) Pub. Date: Jun. 26, 2014

(54) SUBFRAME FOR HOLDING AN ELECTRIC ENERGY ACCUMULATOR IN A MOTOR VEHICLE

(71) Applicant: Dr. Ing. h.c. F .Porche Aktiengesellschaft, Stuttgart (DE)

(72) Inventors: Daniel Knoblauch, Obergruppenbach (DE); Johannes Lange, Wiernsheim (DE)

(73) Assignee: Dr. Ing. h.c. F .Porche Aktiengesellschaft, Stuttgart (DE)

(21) Appl. No.: 14/107,602

(22) Filed: Dec. 16, 2013

(30) Foreign Application Priority Data
Dec. 21, 2012 (DE) 10 2012 112 966.5

(51) Int. Cl. B60K 1/04

(52) U.S. Cl. CPC B60K 1/04
USPC 180/68.5

(57) ABSTRACT

A subframe (1) in a body of a motor vehicle is provided for connecting longitudinal and cross members for wheels (12) of an axle of the motor vehicle. A region (2) of the subframe (1) is designed as a supporting ring (3) for holding an electric energy accumulator (4). The subframe achieves a structurally simple and stable holding of an electric energy accumulator in the motor vehicle.

### CROSS REFERENCE TO RELATED APPLICATION

This application claims priority under 35 USC 119 to German Patent Appl. No. 10 2012 112 966.5 filed on Dec. 21, 2012, the entire disclosure of which is incorporated herein by reference.

### BACKGROUND

1. Field of the Invention

The invention relates to a subframe in a body of a motor vehicle for connecting longitudinal and cross members for wheels of an axle of the motor vehicle.

2. Description of the Related Art

Motor vehicles which have subframes of this type are known from the prior art.

Furthermore, a very wide variety of modifications relating to electrically drivable motor vehicles are known for motor vehicles. In this connection, use is made of electric machines that can be operated as a motor and/or a generator. The motor vehicles are equipped with an electric energy accumulator, such as a high-voltage battery.

DE 10 2010 018 729 A1 describes a motor vehicle with a subframe that forms part of an additional structure of a crumple zone of the motor vehicle. The additional structure has two support planes that are arranged one above the other in the vertical direction of the vehicle. A zone of the upper support plane is rigid against deformation and holds a battery box. Therefore this zone constitutes a safety cell for the battery box, and hence accident-induced damage to the batteries in the battery box is avoided. A further battery box is arranged below the upper support plane in the vertical direction of the vehicle and also is protected by a zone that is rigid against deformation.

DE 10 2010 033 123 A1 discloses an arrangement of an energy accumulator device arranged in an underfloor region on a body shell of a motor vehicle.

US 2008/0283317 A1 describes a protective housing for a vehicle battery in a vehicle. The protective housing is between two longitudinal members of the vehicle body and is connected to the longitudinal members and to a cross member of the vehicle.

It is the object of the invention to provide a subframe that is structurally simple and ensures stable holding of an electric energy accumulator in the motor vehicle.

### SUMMARY OF THE INVENTION

The invention relates to a subframe is designed as a supporting ring for holding the electric energy accumulator. A subframe is intended to be understood as meaning an auxiliary structure configured according to corresponding loading requirements, for example a complex cast structure with struts, shells and ribbing.

The body is designed in the region of the subframe in such a manner that the subframe is a ring that has a supporting function and accordingly is eminently suitable for holding the electric energy accumulator.

The supporting ring preferably has upper and lower supporting structures for the electric energy accumulator. The supporting structures preferably are composed of fiber-reinforced plastic as a particularly lightweight solution; or of aluminum diecasting as a cost effective solution with good thermal conductivity.

The supporting structures preferably are formed by two half shells for holding the energy accumulator. The energy accumulator may be a high-voltage battery.

The subframe also may perform other functions.

The subframe preferably has a bifurcation or doubling for holding at least one power electronics unit for an electric machine. The power electronics unit preferably is arranged directly next to the supporting ring. The subframe also can have a region with fastening elements for at least one electric machine and the longitudinal and transverse links for the wheels of the axle.

At least one electric machine is provided and preferably is operable in a motor mode and a generator mode.

The subframe also can have crash elements.

The subframe preferably is provided with fastening regions for screwing to the body.

The supporting ring of the subframe functions to hold the electric energy accumulator and is arranged in a region that faces away from the rear in the case of a rear drive of the motor vehicle, or faces away from the front in the case of a front drive of the motor vehicle. In the case of a rear drive, the bifurcation or doubling for holding the at least one power electronics unit for the electric machine preferably is located adjacent to and behind the supporting ring. Furthermore, the region with the fastening elements for the electric machine and the longitudinal and transverse links is located behind the bifurcation or doubling. The crash elements are arranged behind this region of the subframe. In the case of a front drive, by contrast, the arrangement of the elements is the other way around. The crash elements therefore are located in the front region of the subframe, and hence in the front region of the motor vehicle. Other elements are arranged more rearward, beginning with the region of the fastening elements, then with the bifurcation or doubling, and finally with the supporting ring.

The crash elements therefore are provided with respect to the front or rear end of the vehicle in order to absorb energy in the event of a crash.

Further features of the invention emerge from the enclosed drawing and the description of the preferred exemplary embodiment, that is reproduced in the drawing, without being restricted thereto.

### BRIEF DESCRIPTION OF THE DRAWINGS

FIG. 1 is a schematic a side view of the subframe in the body of a passenger vehicle, with motor vehicle components assigned to the subframe.

FIG. 2 is a top plan view of the arrangement of FIG. 1.

FIG. 3 is in an enlarged illustration of that region of the subframe that has the bifurcation/doubling.

### DETAILED DESCRIPTION OF THE PREFERRED EMBODIMENTS

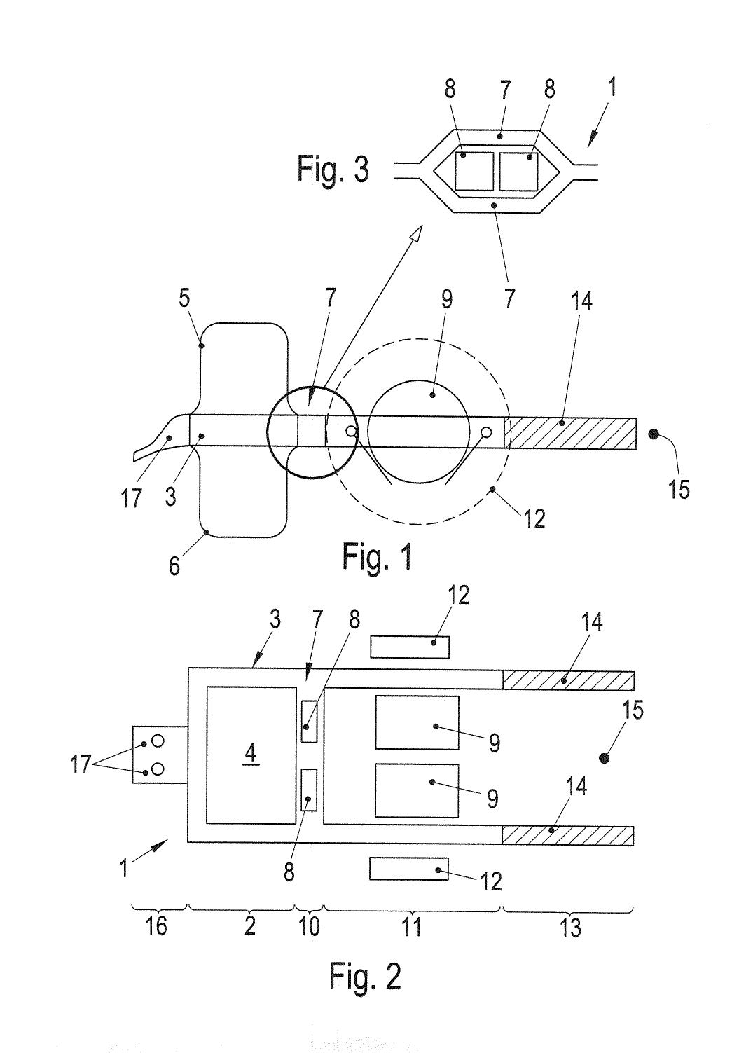

FIGS. 1-3 show a subframe 1 with a region 2 that is designed as a supporting ring 3 for holding an electric energy accumulator 4, which in this instance is a high-voltage battery. The ring 3 holds an upper supporting structure 5 and a lower supporting structure 6 that are composed of fiber-reinforced plastic and are in the form of two half shells for the energy accumulator 4. The ring 3 has a rectangular shape, based on the top view, with a rectangular ring opening.

The subframe 1 has a bifurcation or doubling 7 adjacent to the ring 3 for holding at least one power electronics unit 8 for an electric motor 9. Two electric motors 9 and a power electronics unit 8 assigned to the respective electric motor 9 are illustrated. Adjacent to the bifurcated or doubled region 10, the subframe 1 has a further region 11 with fastening elements (not illustrated) for the two electric motors 9 and longitudinal and transverse links (not illustrated) for wheels 12 of an axle of the passenger vehicle. Finally, the subframe 1 has a region 13 adjacent to the region 11. The region 13 is placed in the region of the front or rear end of the passenger vehicle and in the region of which crash elements 14 are provided for absorbing energy in the event of a crash. Accordingly, the point 15 is either on the front end of the passenger vehicle or the rear end of the passenger vehicle in the longitudinal extent of the subframe 1. The side of the subframe 1 that faces away from the front end or rear end of the subframe 1 has an additional fastening region 16 for screwing the subframe 1 to the rest of the body. In this respect, fastening tabs 17 for the region 16 are illustrated and the screw connection to the rest of the body takes place there. Of course, further connecting points for screwing the subframe 1 to the rest of the body can also be provided in the regions 2, 10 and/or 11.

The invention therefore discloses a particular design of a subframe for producing an integrated electric drive module.

What is claimed is:

1. A subframe in a body of a motor vehicle for connecting longitudinal and cross members for wheels of an axle of the motor vehicle, the subframe comprising a region defining a supporting ring for holding an electric energy accumulator.

2. The subframe of claim 1, wherein the supporting ring has upper and lower supporting structures for the electric energy accumulator.

3. The subframe of claim 2, wherein the supporting structures are composed of fiber-reinforced plastic.

4. The subframe of claim 2, wherein the supporting structures are formed by two half shells.

5. The subframe of claim 1, wherein the subframe has a region with a bifurcation or doubling for holding at least one power electronics unit for an electric machine.

6. The subframe of claim 5, wherein the subframe has a region with fastening elements for at least one electric machine and the longitudinal and transverse links for the wheels of the axle.

7. The subframe of claim 6, wherein the electric machine is operable in a motor mode or in a generator mode.

8. The subframe of claim 6, further comprising crash elements.

9. The subframe of claim 8, wherein the subframe has fastening regions for screwing to the body.

10. The subframe of claim 9, wherein the crash elements are arranged in a region of a front or rear end of the vehicle.

11. The subframe of claim 10, wherein the region with the fastening elements for the at least one electric machine and the longitudinal and transverse links for the wheels of the axle are arranged adjacent to the crash elements, and is arranged between the crash elements and the region of the bifurcation/doubling, and the region of the bifurcation/doubling is arranged between the region with the fastening elements and the region which has the ring.

12. The subframe of claim 5, wherein the region that has the ring is arranged directly next to the region of the subframe that holds a power electronics unit (8).
